(19) United States
(12) Patent Application Publication
(10) Pub. No.: US 2015/0309976 A1
(43) Pub. Date: Oct. 29, 2015

(54) ELECTRONIC DEVICE AND METHOD FOR EDITING DOCUMENTS

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: LIAN BAI, Shenzhen (CN); CHIH-HUA HSU, New Taipei (TW)

(21) Appl. No.: 14/696,633

(22) Filed: Apr. 27, 2015

(30) Foreign Application Priority Data
Apr. 28, 2014 (CN) 201410173470.8

(51) Int. Cl. G06F 17/24; G06F 17/30; G06F 3/0481; G06F 3/0484

(52) U.S. Cl. CPC G06F 17/24; G06F 3/0484; G06F 17/30011; G06F 3/04812; G06F 2203/04806

(57) ABSTRACT

An electronic device and document editing method are provided. Programs in a storage device, executed by at least one processor, cause the at least one processor to display an interface showing a first electronic document including an insertion area having a first size; determine whether a touch operation applied on the interface showing the first electronic document is an editing operation; adjust size of the insertion area based on the touch operation if the touch operation is the editing operation to a second size that is different from the first size; and locate a selected object on the adjusted insertion area if the selected object is moved toward and overlapping the adjusted insertion area, the selected object being a copy of an object displayed on an interface showing a second electronic document.

### CROSS-REFERENCE TO RELATED APPLICATIONS

This application claims priority to Chinese Patent Application No. 201410173470.8 filed on Apr. 28, 2014, the contents of which are incorporated by reference herein.

### FIELD

The subject matter herein generally relates to electronic document editing.

### BACKGROUND

Electronic devices can store many electronic documents. An electronic document can be edited by operations of a user.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a document editing system.

FIG. 2 shows an interface displayed on the electronic device of FIG. 1, showing a first electronic document and a second electronic document.

FIGS. 3-5 show interfaces during a process for editing the first electronic document of FIG. 2, in accordance with a first embodiment.

FIG. 6 shows an interface displayed on the electronic device of FIG. 1, showing a third electronic document.

FIGS. 7-11 show interfaces during a process for editing the third electronic document of FIG. 6, in accordance with a second embodiment.

FIG. 12 is a flowchart of a first embodiment of a document editing method of an electronic device, such as the one of FIG. 1.

FIG. 13 is a flowchart of a second embodiment of a document editing method of an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. Some non-limiting examples of non-transitory computer-readable media include CDs, DVDs, BLUE-RAY, flash memory, and hard disk drives. The term “comprising” means “including, but not necessarily limited to”; it specifically indicates open-ended inclusion or membership in a so-described combination, group, series and the like.

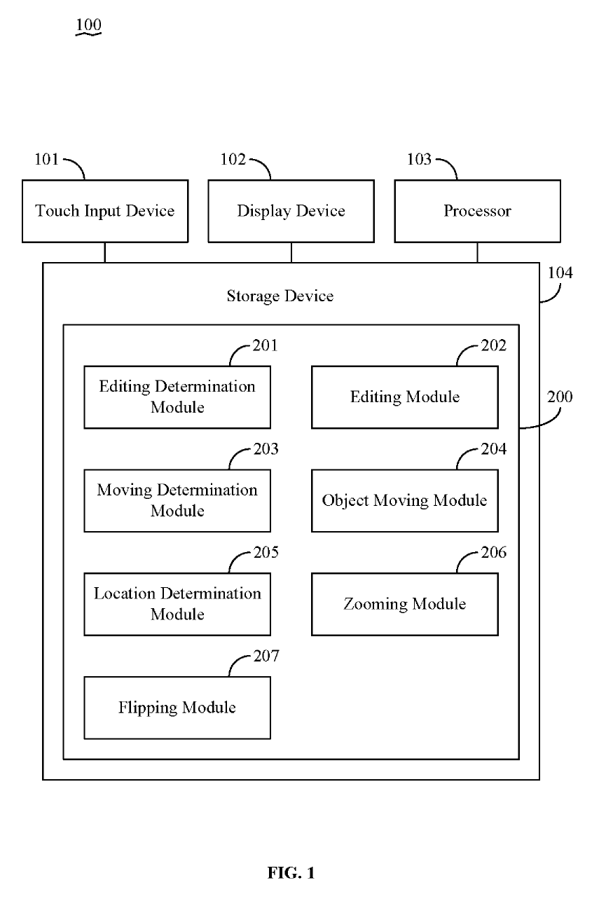

FIG. 1 illustrates an embodiment of an electronic device 100. A document editing system 200 is applied to the electronic device 100. The electronic device 100 can be mobile phone or a tablet computer, or other portable device. The electronic device 100 can include a touch input device 101 and a display device 102. The electronic device 100 can also include at least one processor 103 and a storage device 104. In at least one embodiment, the electronic device 100 includes one processor 103. The processor 103 executes instructions of a number of modules stored in the storage device 104. The storage device 104 can store an editing determination module 201, an editing module 202, a moving determination module 203, an object moving module 204, a location determination module 205, a zooming module 206 and a flipping module 207.

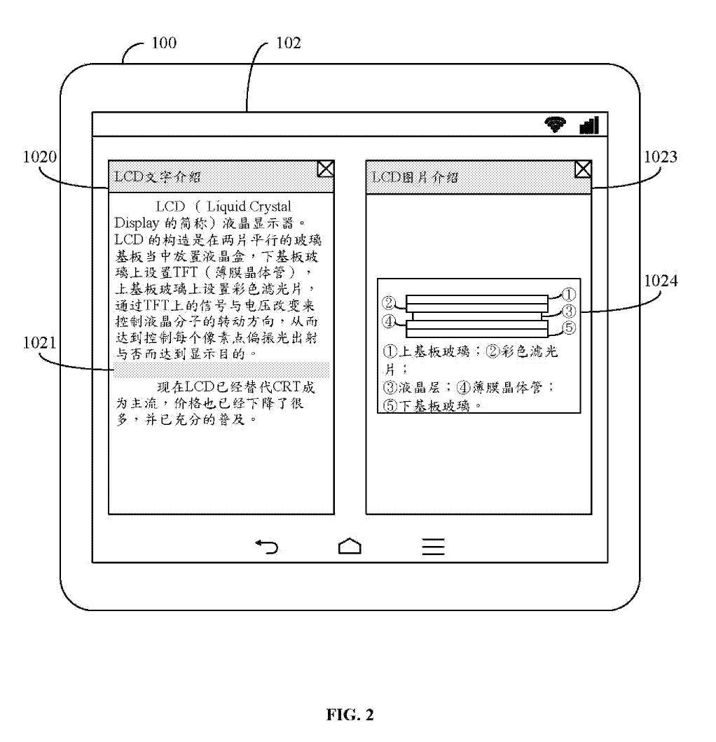

Referring to FIG. 2, the display device 102 can display a first electronic document 1020 and a second electronic document 1023. In at least one embodiment, the first electronic document and the second electronic document 1023 are displayed on the display device 102 at the same time, and the size of an interface showing the first electronic document 1020 can be adjusted under a touch operation of a user, the size of an interface showing the second electronic document 1023 can also be adjusted under a touch operation of the user. A first insertion area 1021 having a first size is displayed on the interface showing the first electronic document 1020, and a first object 1024 is displayed on the interface showing the second electronic document 1023. In at least one embodiment, the first insertion area 1021 is a blank area between two adjacent paragraphs; the first object 1024 includes at least one picture and a number of characters.

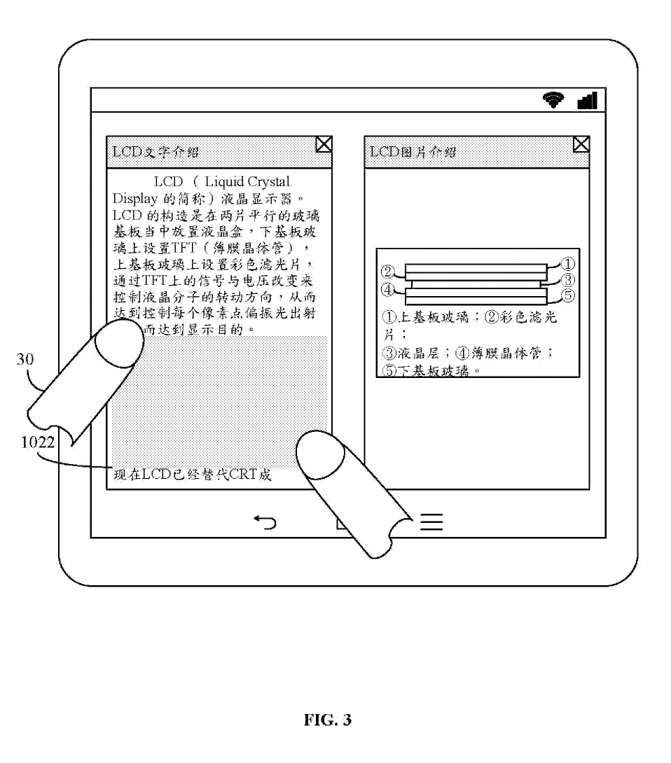

Referring to FIG. 3, the touch input device 101 detects one or more touch points, and the editing determination module 201 determines whether a touch operation on the touch input device 101 is an editing operation according to the touch points. In at least one embodiment, if the touch operation on the touch input device 101 includes: at least two touch points are applied on the first insertion area 1021, and then at least one of the two touch points moves on the interface showing the first electronic document 1021, the editing determination module 201 determines the touch operation is an editing operation.

The editing module 202 adjusts size of the first insertion area 1021 and obtains a first adjusted insertion area 1022 having a second size that is different from the first size, if the editing determination module 201 determines that the touch operation is an editing operation. In at least one embodiment, the editing module 202 determines a straight line between the two touch points has been moved as a diagonal of a rectangle, and further determines the rectangle as the first adjusted insertion area 1022.

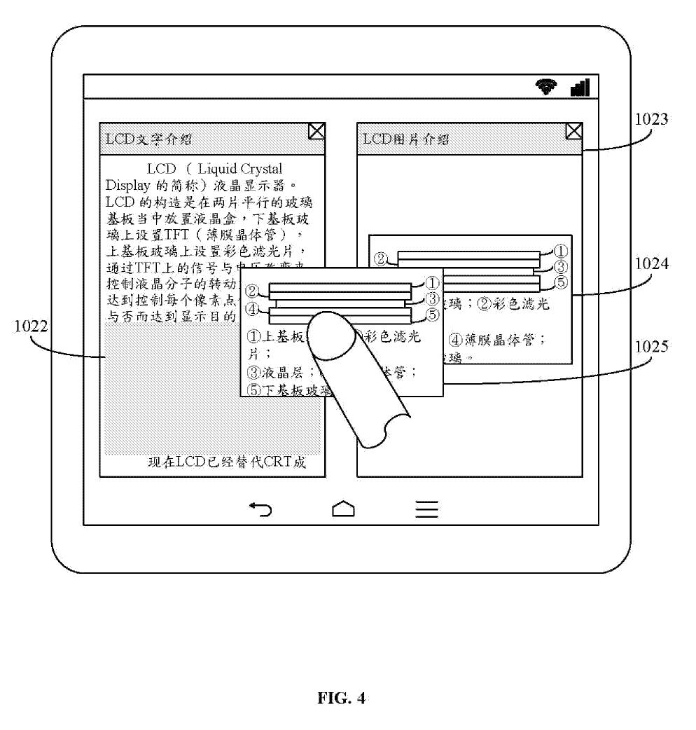

Referring to FIG. 4, the touch input device 101 detects a touch input on the first object 1024, the moving determination module 203 times a first time period of the touch input on the first object 1024 and determines whether the first time period is equal to or longer than a first preset time period. If the first time period is equal to or longer than the first preset time period, the moving determination module 203 determines that the touch input on the first object 1024 is an object move operation. In response to the object move operation, the object moving module 204 copies the first object 1024 and obtains a first copied object 1025, actuates the first copied object 1025 into a movable state. If the first time period is shorter than the first preset time period, the moving determination module 203 determines that the touch input on the first object 1024 is an object click operation.

The touch input device 101 detects a drag operation on the first copied object 1025. In at least one embodiment, the object moving module 204 controls the display device 102 to update the location of the first copied object 1025 according to the drag operation.

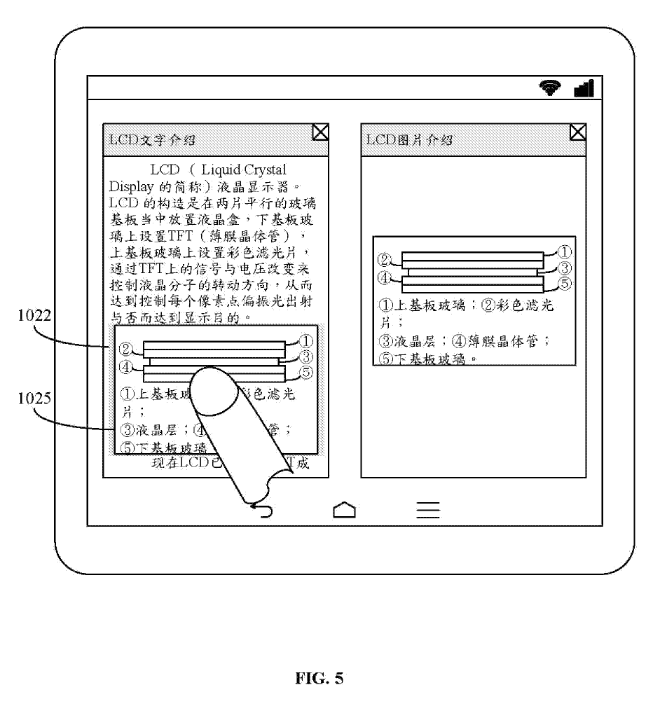

Referring to FIG. 5, after the drag operation ends, the location determination module 205 determines whether the first copied object 1025 is on the first adjusted insertion area 1022 according to the location of the touch input of the drag operation. In at least one embodiment, if at least one part of the first copied object 1025, for example half of the first copied object 1025, is overlapping the first adjusted insertion area 1022, the location determination module 205 determines the first copied object 1025 is on the first adjusted insertion area 1022. If the first copied object 1025 is on the first adjusted insertion area 1022, the location determination module 205 locates the first copied object 1025 on the first adjusted insertion area 1022 and controls the display device 102 to display the first copied object 1025 on the first adjusted insertion area 1022. In at least one embodiment, the location determination module 205 locates the first copied object 1025 on the center of the first adjusted insertion area 1022.

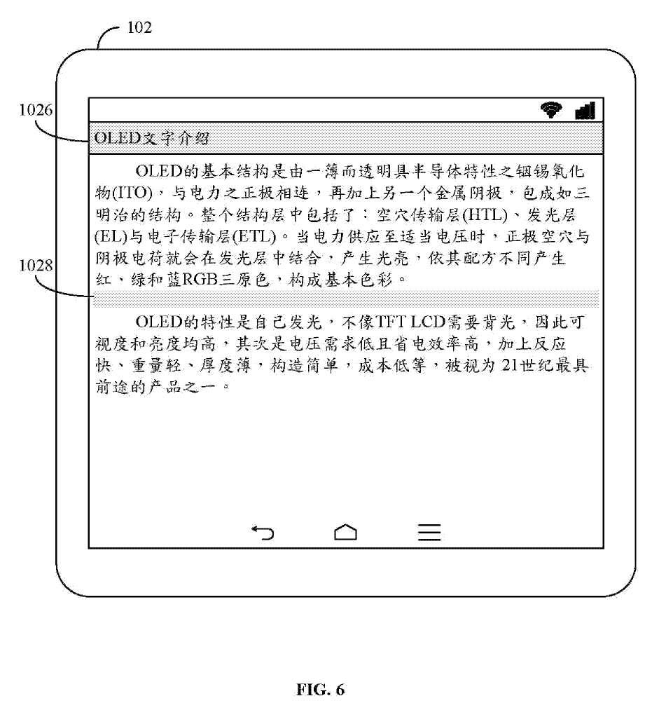

Referring to FIG. 6, the display device 102 can display a third electronic document 1026. In at least one embodiment, the third electronic document 1026 is displayed on the whole display device 102 and the size of an interface showing the third electronic document 1026 cannot be adjusted. A second insertion area 1028 having a first size is displayed on the interface showing the third electronic document 1026. In at least one embodiment, the second insertion area 1028 is a blank area between two adjacent paragraphs.

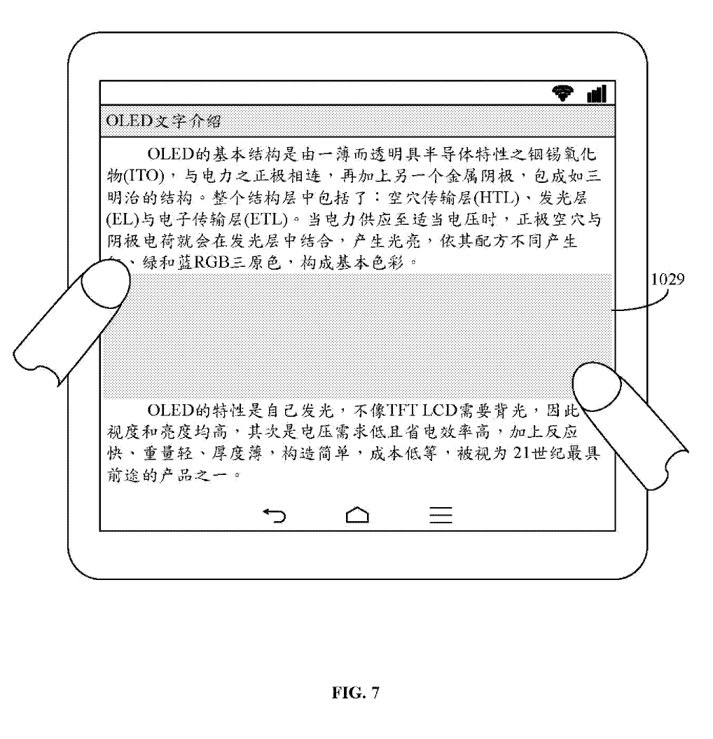

Referring to FIG. 7, the touch input device 101 detects one or more touch points, and the editing determination module 201 determines whether a touch operation on the touch input device 101 is an editing operation according to the touch points. In at least one embodiment, if the touch operation on the touch input device 101 includes: at least two touch points are applied on the first insertion area 1021, and at least one of the two touch point moves on the interface showing the third electronic document 1026, the editing determination module 201 determines the touch operation is an editing operation.

The editing module 202 adjusts a size of the second insertion area 1026 and obtains a second adjusted insertion area 1029 having a second size that is different from the first size, if the editing determination module 201 determines that the touch operation is an editing operation. In at least one embodiment, the editing module 202 determines that a straight line between the two touch points has been moved as a diagonal of a rectangle, and further determines the rectangle as the second adjusted insertion area 1029.

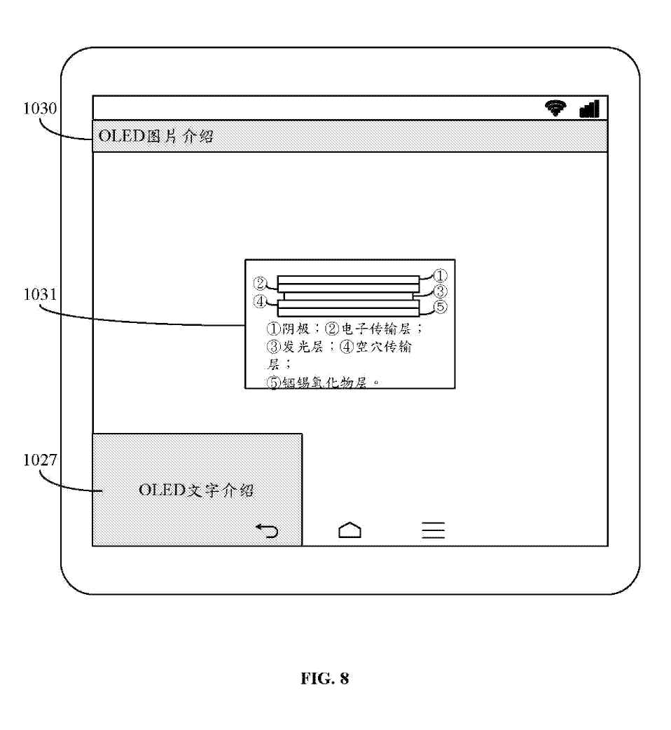

Referring to FIG. 8, the zooming module 206 creates a zoomed interface 1027 of the interface of the third electronic document 1026 in response to an operation for opening a fourth electronic document 1030. The display device 102 displays the zoomed interface 1027 and an interface showing the fourth electronic documents 1030. In at least one embodiment, a second object 1031 is displayed on the interface showing the fourth electronic document 1030, the second object 1031 includes at least one picture and a number of characters. In at least one embodiment, the zoomed interface 1027 is a rectangle area which is displayed on a corner of the display device 102, and the name of the third electronic document 1026 is displayed on the zoomed interface 1027.

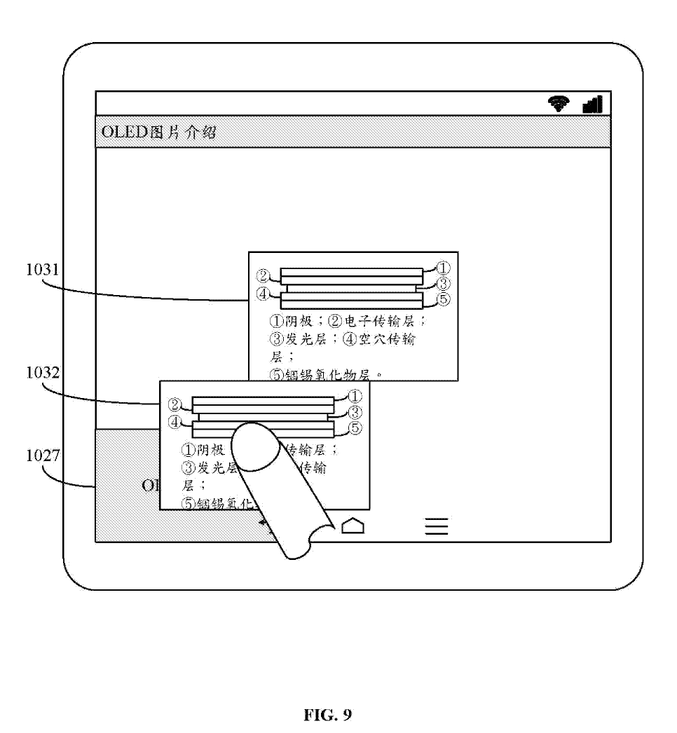

Referring to FIG. 9, the touch input device 101 detects a touch input on the second object 1031, the moving determination module 203 times a second time period of the touch input on the second object 1031 and determines whether the second time period is equal to or longer than a second preset time period. If the second time period is equal to or longer than the second preset time period, the moving determination module 203 determines that the touch input on the second object 1031 is an object move operation. In response to the object move operation, the object moving module 204 copies the second object 1031 and obtains a second copied object 1032, actuates the second copied object 1032 into a movable state. If the second time period is shorter than the second preset time period, the moving determination module 203 determines that the touch input on the second object 1031 is an object click operation.

The touch input device 101 detects a drag operation on the second copied object 1032. In at least one embodiment, the object moving module 204 controls the display device 102 to update the location of the second copied object 1032 according to the drag operation.

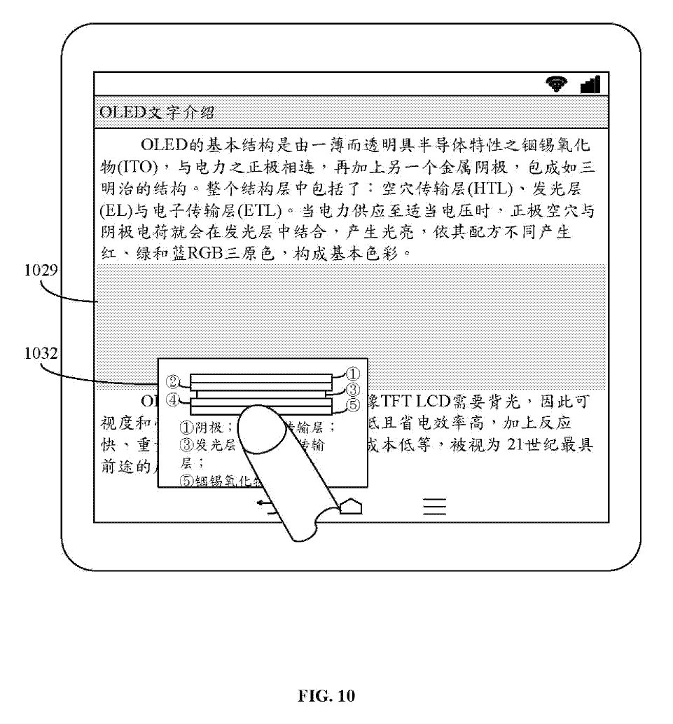

Referring to FIG. 10, the flipping module 207 determines whether the second copied object 1032 is on the zoomed interface 1027 according to the location of the touch input of the drag operation. In at least one embodiment, if more than part of the second copied object 1032, for example half of the second copied object 1032, is overlapping the zoomed interface 1027, the flipping module 207 determines the second copied object 1032 is on the zoomed interface 1027. If the second copied object 1032 is on the zoomed interface 1027, the flipping module 207 controls the display device 102 to display the interface showing the third electronic document 1026 and to display the second copied object 1032 on the interface showing the third electronic document 1026.

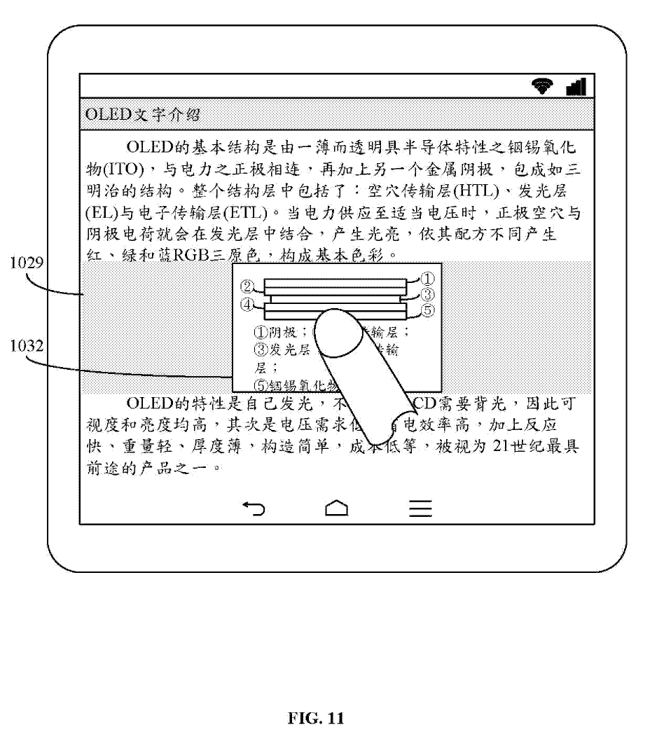

Referring to FIG. 11, after the drag operation ends, the location determination module 205 determines whether the second copied object 1032 is on the second adjusted insertion area 1029 according to the location of the touch input of the drag operation. In at least one embodiment, if more than one part of the second copied object 1032, for example half of the second copied object 1032, is overlapping the second adjusted insertion area 1029, the location determination module 205 determines the second copied object 1032 is on the second adjusted insertion area 1029. If the second copied object 1032 is on the second adjusted insertion area 1029, the location determination module 205 locates the second copied object 1032 on the second adjusted insertion area 1029 and controls the display device 102 to display the second copied object 1032 on the second adjusted insertion area 1029. In at least one embodiment, the location determination module 205 locates the second copied object 1032 on the center of the second adjusted insertion area 1029.

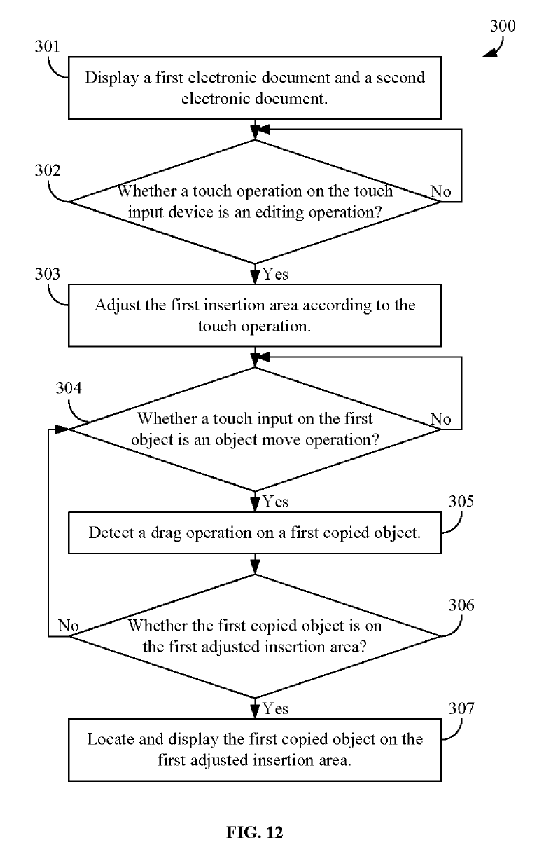

Referring to FIG. 12, a flowchart is presented in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 12 represents one or more processes, methods, or routines, carried out in the exemplary method 300. Additionally, the illustrated order of blocks is by example only and the order of the blocks can be changed. The exemplary method 300 can begin at block 301.

At block 301, a display device displays a first electronic document and a second electronic document. In at least one embodiment, the first electronic document and the second electronic document are displayed on the display device at the same time, and the size of an interface showing the first electronic document can be adjusted under a touch operation of a user, the size of an interface showing the second electronic document can also be adjusted under a touch operation of the user. A first insertion area having a first size is displayed on the interface showing the first electronic document, and a first object is displayed on the interface showing the second electronic document. In at least one embodiment, the first insertion area is a blank area between two adjacent paragraphs; the first object includes at least one picture and a number of characters.

At block 302, a touch input device detects one or more touch points, and an editing determination module determines whether a touch operation on the touch input device is an editing operation according to the touch points. In at least one embodiment, if the touch operation on the touch input device includes: at least two touch points are applied on the first insertion area, and at least one of the two touch points moves on the interface showing the first electronic document, the editing determination module determines the touch operation is an editing operation. If the editing determination module determines that the touch operation is an editing operation, block 303 is implemented. If the editing determination module determines that the touch operation is not an editing operation, block 302 is repeated.

At block 303, an editing module adjusts size of the first insertion area and obtains a first adjusted insertion area having a second size that is different from the first size. In at least one embodiment, the editing module determines a straight line between the two touch points has been moved as a diagonal of a rectangle and further determines the rectangle as the first adjusted insertion area.

At block 304, the touch input device detects a touch input on the first object, a moving determination module determines whether the touch input on the first object is an object move operation. In at least one embodiment, the moving determination module times a first time period of the touch input on the first object and determines whether the first time period is equal to or longer than a first preset time period. If the first time period is equal to or longer than the first preset time period, the moving determination module determines that the touch input on the first object is the object move operation. In response to the object move operation, an object moving module copies the first object and obtains a first copied object, actuates the first copied object into a movable state, and block 305 is implemented. If the first time period is shorter than the first preset time period, the moving determination module determines that the touch input on the first object is an object click operation, and block 304 is repeated.

At block 305, the touch input device detects a drag operation on the first copied object. In at least one embodiment, the object moving module controls the display device to update the location of the first copied object according to the drag operation.

At block 306, after the drag operation ends, a location determination module determines whether the first copied object is moved toward and overlapping the first adjusted insertion area according to the location of the touch input of the drag operation. If the first copied object is on the first adjusted insertion area, block 307 is implemented.

If the first copied object is not on the first adjusted insertion area, the process goes back to block 304.

At block 307, the location determination module locates the first copied object on the first adjusted insertion area and controls the display device to display the first copied object on the first adjusted insertion area. In at least one embodiment, the location determination module locates the first copied object on the center of the first adjusted insertion area.

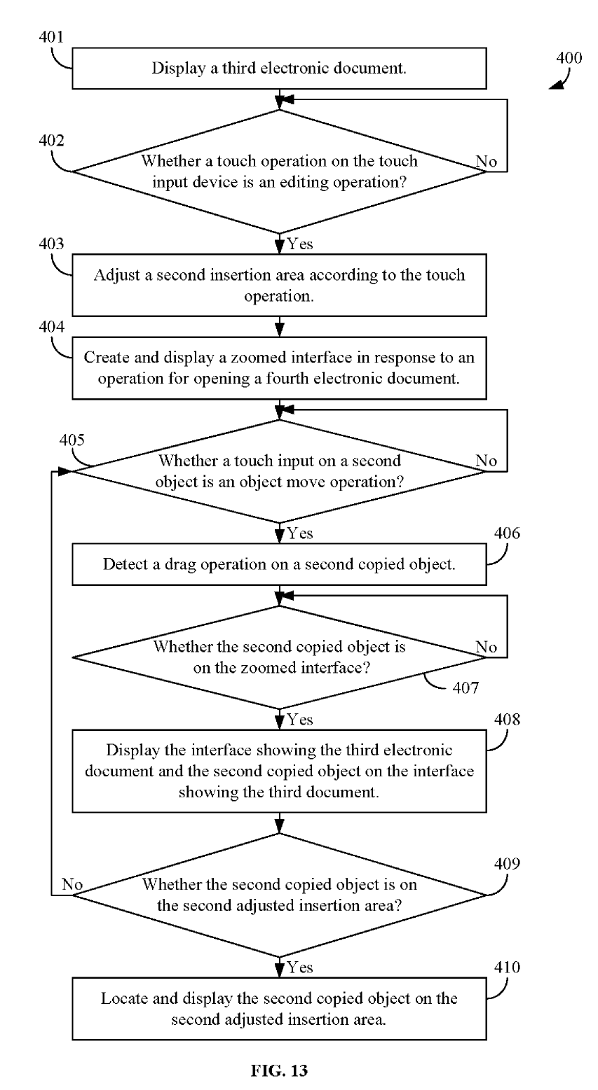

Referring to FIG. 13, a flowchart is presented in accordance with an example embodiment. A method 400 is provided by way of example, as there are a variety of ways to carry out the method. The method 400 described below can be carried out using the configurations illustrated in FIG. 1 and various elements of these figures are referenced in explaining example method 400. Each block shown in FIG. 13 represents one or more processes, methods, or routines, carried out in the exemplary method 400. Additionally, the illustrated order of blocks is by example only and the order of the blocks can be changed. The exemplary method 400 can begin at block 401.

At block 401, a display device displays a third electronic document. In at least one embodiment, the third electronic document is displayed on the whole display device and the size of an interface showing the third electronic document cannot be adjusted. A second insertion area having a first size is displayed on the interface showing the third electronic document. In at least one embodiment, the second insertion area is a blank area between two adjacent paragraphs.

At block 402, a touch input device detects one or more touch points, and an editing determination module determines whether a touch operation on the touch input device is an editing operation according to the touch points. In at least one embodiment, if the touch operation includes: at least two touch points are applied on the first insertion area, and at least one of the two touch points moves on the interface showing the third electronic document, the editing determination module determines the touch operation is an editing operation. If the editing determination module determines that the touch operation on the touch input device is an editing operation, block 403 is implemented. If the editing determination module determines that the touch operation on the touch input device is not an editing operation, block 402 is repeated.

At block 403, an editing module adjusts the second insertion area and obtains a second adjusted insertion area having a second size that is different from the first size. In at least one embodiment, the editing module determines a straight line between the two touch points has been moved as a diagonal of a rectangle, and further determines the rectangle as the second adjusted insertion area.

At block 404, a zooming module creates a zoomed interface of the interface of the third electronic document in response to an operation for opening a fourth electronic document. The zooming module also controls the display device to display the zoomed interface and the interface of the fourth electronic document. In at least one embodiment, a second object is displayed on the interface showing the fourth electronic document, the second object includes at least one picture and a number of characters. In at least one embodiment, the zoomed interface is a rectangle area which is displayed on a corner of the display device, and the name of the third electronic document is displayed on the zoomed interface.

At block 405, the touch input device detects a touch input on the second object, a moving determination module determines whether the touch input on the second object is an object move operation. In at least one embodiment, the moving determination module times a second time period of the touch input on the second object and determines whether the second time period is equal to or longer than a second preset time period. If the second time period is equal to or longer than the second preset time period, the moving determination module determines that the touch input on the second object is the object move operation. In response to the object move operation, the object moving module copies the second object and obtains a second copied object, actuates the second copied object into a movable state, and block 406 is implemented. If the second time period is shorter than the second preset time period, the moving determination module determines that the touch input on the second object is an object click operation, and block 405 is repeated.

At block 406, the touch input device detects a drag operation on the second copied object. In at least one embodiment, the object moving module controls the display device to update the location of the second copied object according to the drag operation.

At block 407, a flipping module determines whether the second copied object is moved toward and overlapping the zoomed interface according to the location of the touch input of the drag operation. If the second copied object is overlapping the zoomed interface, block 408 is implemented. If the second copied object is not overlapping the zoomed interface, block 407 is repeated.

At block 408, the flipping module controls the display device to display the interface showing the third electronic document and to display the second copied object on the interface showing the third electronic document.

At block 409, after the drag operation ends, the location determination module determines whether the second copied object is moved toward and overlapping the second adjusted insertion area according to the location of the touch input of the drag operation. If the second copied object is overlapping the second adjusted insertion area, block 410 is implemented. If the second copied object is not overlapping the second adjusted insertion area, the process goes back to block 405.

At block 410, the location determination module locates the second copied object on the second adjusted insertion area and controls the display device to display the second copied object on the second adjusted insertion area. In at least one embodiment, the location determination module locates the second copied object on the center of the second adjusted insertion area.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
at least one processor; and
a non-transitory storage medium coupled to the at least one processor and storing one or more programs, which when executed by the at least one processor, cause the at least one processor to:
display an interface showing a first electronic document comprising an insertion area having a first size;
determine whether a touch operation applied on the interface showing the first electronic document is an editing operation;
adjust the insertion area based on the touch operation if the touch operation is the editing operation to a second size that is different from the first size; and
locate a selected object on the adjusted insertion area if the selected object is moved toward and overlapping the adjusted insertion area, wherein the selected object is a copy of an object displayed on an interface showing a second electronic document.

2. The electronic device of claim 1, wherein in “determine whether a touch operation applied on the interface showing the first electronic document is an editing operation”, the at least one processor further:
detect one or more touch points on the insertion area; and
determine the touch operation is the editing operation if at least two touch points are applied on the insertion area and at least one of the two touch points moves on the interface showing the first electronic document.

3. The electronic device of claim 1, wherein in “adjust the insertion area based on the touch operation if the touch operation is the editing operation to a second size that is different from the first size”, the at least one processor further:
determine a straight line between the at least two touch points been moved as a diagonal of a rectangle; and
determine the rectangle as the adjusted insertion area.

4. The electronic device of claim 1, wherein before “locate an object on the adjusted insertion area if the object is moved toward and overlapping the adjusted insertion area”, the at least one processor further:
detect a touch input on the object;
time a time period of the touch input on the object and determine whether the time period is equal to or longer than a preset time period;
determine that the touch input on the object is an object move operation if the time period of the touch input on the object is equal to or longer than a preset time period; and
copy the object as the selected object.

5. The electronic device of claim 4, wherein the at least one processor further:
create a zoomed interface of the interface showing the first electronic document in response to an operation for opening the second electronic document;
display the zoomed interface and the interface showing the first electronic document;
determine whether a touch input on the object is the object move operation;
copy the object as the selected object if the touch input is the object move operation;
display the interface showing the first electronic document if the selected object is moved toward and overlapping the zoomed interface; and
locate the selected object on the adjusted insertion area if the selected object is moved toward and overlapping the adjusted insertion area.

6. The electronic device of claim 5, wherein the zoomed interface is a rectangle area which is displayed at a corner of a display device, and the name of the first electronic document is displayed on the zoomed interface.

7. The electronic device of claim 5, wherein in “display the interface showing the first electronic document if the selected object is moved toward and overlapping the zoomed interface”, the at least one processor further:
detect a drag operation on the selected object; and
determine whether the selected object is moved toward and overlapping the zoomed interface according to the drag operation.

8. A computer-based method for editing documents for an electronic device being executed by at least one processor of the electronic device, the method comprising:
displaying an interface showing a first electronic document comprising an insertion area having a first size;
determining whether a touch operation applied on the interface showing the first electronic document is an editing operation;
adjusting the insertion area based on the touch operation if the touch operation is the editing operation to a second size that is different from the first size; and
locating a selected object on the adjusted insertion area if the selected object is moved toward and overlapping the adjusted insertion area, wherein the selected object is a copy of an object displayed on an interface showing a second electronic document.

9. The method of claim 8, wherein in “determining whether a touch operation applied on the interface showing the first electronic document is an editing operation”, the method comprising:
detecting one or more touch points on the insertion area; and
determining the touch operation is the editing operation if at least two touch points are applied on the insertion area and at least one of the two touch points moves on the interface showing the first electronic document.

10. The method of claim 8, wherein in “adjusting the insertion area based on the touch operation if the touch operation is the editing operation to a second size that is different from the first size”, the method comprising:
determining a straight line between the at least two touch points been moved as a diagonal of a rectangle; and
determining the rectangle as the adjusted insertion area.

11. The method of claim 8, wherein before “locating a selected object on the adjusted insertion area if the selected object is moved toward and overlapping the adjusted insertion area”, the method comprising:
detecting a touch input on the object;
timing a time period of the touch input on the object and determine whether the time period is equal to or longer than a preset time period;
determining that the touch input on the object is an object move operation if the time period of the touch input on the object is equal to or longer than a preset time period; and
coping the object as the selected object.

12. The method of claim 11, wherein the method further comprising:
creating a zoomed interface of the interface showing the first electronic document in response to an operation for opening the second electronic document;
displaying the zoomed interface and the interface showing the first electronic document;
determining whether a touch input on the object is the object move operation;
coping the object as the selected object if the touch input is the object move operation;
displaying the interface showing the first electronic document if the selected object is moved toward and overlapping the zoomed interface; and
locating the selected object on the adjusted insertion area if the selected object is moved toward and overlapping the adjusted insertion area.

13. The method of claim 12, wherein the zoomed interface is a rectangle area which is displayed at a corner of a display device, and the name of the first electronic document is displayed on the zoomed interface.

14. The method of claim 12, wherein in “displaying the interface showing the first electronic document if the selected object is moved toward and overlapping the zoomed interface”, the method comprising:
detecting a drag operation on the selected object; and
determining whether the selected object is moved toward and overlapping the zoomed interface according to the drag operation.

15. A non-transitory storage medium having stored thereon instructions that, when executed by a processor of an electronic device, causes the processor to perform a documents editing method, wherein the method comprises:
displaying an interface showing a first electronic document comprising an insertion area having a first size;
determining whether a touch operation applied on the interface showing the first electronic document is an editing operation;
adjusting the insertion area based on the touch operation if the touch operation is the editing operation to a second size that is different from the first size; and
locating a selected object on the adjusted insertion area if the selected object is moved toward and overlapping the adjusted insertion area, the selected object being a copy of an object displayed on an interface showing a second electronic document.

16. The non-transitory storage medium according to claim 15, wherein in “determining whether a touch operation applied on the interface showing the first electronic document is an editing operation”, the method comprising:
detecting one or more touch points on the insertion area; and
determining the touch operation is the editing operation if at least two touch points are applied on the insertion area and at least one of the two touch points moves on the interface showing the first electronic document.

17. The non-transitory storage medium according to claim 15, wherein in “adjusting the insertion area based on the touch operation if the touch operation is the editing operation to a second size that is different from the first size”, the method comprising:
determining a straight line between the at least two touch points been moved as a diagonal of a rectangle; and
determining the rectangle as the adjusted insertion area.

18. The non-transitory storage medium according to claim 15, wherein before “locating a selected object on the adjusted insertion area if the selected object is moved toward and overlapping the adjusted insertion area”, the method comprising:
detecting a touch input on the object;
timing a time period of the touch input on the object and determine whether the time period is equal to or longer than a preset time period;
determining that the touch input on the object is an object move operation if the time period of the touch input on the object is equal to or longer than a preset time period; and
coping the object as the selected object.

19. The non-transitory storage medium according to claim 18, wherein the method further comprising:
creating a zoomed interface of the interface showing the first electronic document in response to an operation for opening the second electronic document;
displaying the zoomed interface and the interface showing the first electronic document;
determining whether a touch input on the object is the object move operation;
coping the object as the selected object if the touch input is the object move operation;
displaying the interface showing the first electronic document if the selected object is moved toward and overlapping the zoomed interface; and
locating the selected object on the adjusted insertion area if the selected object is moved toward and overlapping the adjusted insertion area.

20. The non-transitory storage medium according to claim 19, wherein the zoomed interface is a rectangle area which is displayed at a corner of a display device and the name of the first electronic document is displayed on the zoomed interface.
